(19) United States
(12) Patent Application Publication
(10) Pub. No.: US 2016/0031691 A1
(43) Pub. Date: Feb. 4, 2016

(54) Plant for applying protective membranes on beverage cans

(71) Applicant: RIBI PACK SPA, Genova (IT)

(72) Inventor: Léon Antoine Ribi, Massongex (CH)

(73) Assignee: RIBI PACK SPA, Genova (IT)

(21) Appl. No.: 14/774,631

(22) PCT Filed: Mar. 13, 2013
(86) PCT No.: PCT/IB2013/051966

§ 371 Date: Sep. 10, 2015

(51) Int. Cl. B67B 5/03

(52) U.S. Cl. CPC B67B 5/034

(57) ABSTRACT

A rotating plant for the application of protective membranes of a stretchable plastic polymer on the upper rim of beverage cans includes equal operating devices movable along radial trajectories of a turntable that provide for the circular movement, the radial movement and the vertical movement required and sufficient for applying the membranes.

### FIELD OF THE INVENTION

The present invention relates to a system and plant for applying protective membranes on beverage cans.

### BACKGROUND OF THE INVENTION

The use of cans such as pull-tab quick opening metal sealed containers has been fast growing for some decades because of their efficacy.

Moreover, the manufacture of said cans is implemented by now and it follows general processes that have found both the acceptance by customers and acceptable packaging costs.

The use of metal instead of plastic polymers for making said containers, among other things, allows a particularly environmentally-friendly recycling of the base material unlike the containers made of plastic materials.

In time, however, sanitary problems have arisen that currently are still unsolved, particularly those related to the opening of the cans. The simple fact of pouring the beverage in a glass from a torn opening whose outer surface may have been contaminated formerly, or even worse the fact of drinking directly from the torn opening can result in severe oral or gastrointestinal infections.

In the last years, contaminations of the external surfaces of cans have taken place due to various microbial strains and particularly contaminations by microbial strains of leptospirosis, probably occurred during the storage of the cans in unhygienic rooms, especially under hot climates and in the possible presence of rats.

### SUMMARY OF THE INVENTION

The present invention relates to a plant intended to apply without using adhesives a waterproof membrane of a suitable plastic polymer, or seal, which covers and strongly adheres to the upper circular rim of the can and so it is intended to protect also the pull-tab opening of the can. Previous attempts have been made with plastic covers (caps) forced on the upper rim of the cans or with aluminum metal covers, even glued ones, which however besides being more expensive they have also a poor sealing effect, and therefore they are not so much effective in preventing contaminated liquids or condensations from infiltrating.

### DETAILED DESCRIPTION OF A PREFERRED EMBODIMENT

A plant according to the present invention is essentially composed of a turntable 1 rotating around an axis, which is made of two flat rigid rings 2,3, integral with each other, connected to said axis, which is driven by an electric motor, also by a transmission toothed belt 4, equipped with the relevant running, stopping and controlled speed controls.

Each of the two rings 2, 3 bears an equal number of radial rails or guides 5 in a variable number, depending on the size of the plant, integral with said two rings 2,3 and having angular distances therebetween that are all equal and constant in both the rings 2,3, while each guide 5 of the upper ring 2 is located on the same vertical radial plane of a guide 5 of the lower ring 3.

An operating device 6 corresponds to each pair of guides 5 or rails lying on the same vertical plane, it is radially movable along said two guides 5, and is intended to grasp, retain, seal and subsequently release the cans 7 on whose top the protective membrane 8 has been applied.

This operating device 6 is intended to translate the cans 7, pushing them vertically, by means of a vertical rod 9 equipped with a suitable plate 10 arranged on the upper end and with a caged lubricated rotating ball 11 at the lower end.

The vertical motion takes place by means of a track 12 that is rigid and integral with the base frame, about twenty millimeters wide, whose central axis lies on the surface of a cylinder with a diameter anyway greater than those of the two rings 2,3 and upon which a lubricated ball 11 caged on the vertical rod 9 of the operating device 6 slides. Said closed annular track 12, without interruptions, obviously develops along a continuous plane that changes in level with several slopes between a horizontal higher level L1 and a lower one L2, and thus behaves like a cam that causes said vertical motion of the rods 9 by means of the rotation of the two rings 2, 3 that drive all the operating devices 6.

Moreover said operating devices 6 are radially movable along said guides 5 by means of the action of horizontal rolling bearings 13 mounted at the end of arms 14 integral with the operating devices 6, which slide inside an annular groove 15, formed in a flat ring 16, with a variable diameter and a constant width only higher than the diameter of said bearings 13, which ring 16 with the relevant groove 15 is also integral with the base frame. Said groove 15 behaves like a horizontal cam for changing the radial widths of the operating devices 6.

### The Turntable

The turntable 1 is composed of two rigid horizontal rings 2, 3 held together by webs 17 such to form a rigid rotating structure. Said rotating structure is supported by other three rings 18, 19, 20, integral one with the other of which the two lower ones 18, 20 bear a circular groove 21 that slides on balls that in turn slide in a groove 22 obtained on the outer surface of a base ring or disc. The drive, by means of a toothed belt 4, is applied on the outer surface of the intermediate ring 19. On the two rigid rings 2,3 there are radial guides 5 translating the operating devices 6. Said guides 5 are angularly equally spaced from each other and all the guides 5 of the upper ring 2 are at the precise vertical of the same number of corresponding guides 5 attached to the lower ring 3.

The rotation of the turntable 1 is preferably guaranteed by a powered electric motor that transmits the rotation to the turntable 1 through said toothed belt 4.

Moreover, fastened to or attached to the base structure of the plant supporting the turntable 1, there are provided:

1) A series of operating devices 6;

2) A variable level track 12, acting as a vertical cam with a diameter greater than that of the two rings 2 and 3 that allows the rods 9 of the operating devices 6 to vertically move;

3) A programmed profile horizontal cam 35 which controls the opening and closing of the upper clamp 23;

4) A horizontal cam in the form of a groove 15 and with a preferably rectangular section formed in a rigid ring 16 for radially moving the operating devices 6;

5) A circular horizontal cam 54 with a variable radius profile for controlling the linkage 50;

6) A plate 26 with a lead-in for receiving the output sealed cans 7 and for directing them to the output rotating star 27;

7) A horizontal circular duct 24 equipped with a longitudinal slit 25 for feeding hot air or a similar device.

### The Operating Device

The operating devices 6 are the movable members that circularly, radially and vertically move the cans 7 during the sealing operation.

Said operating devices 6 rotate driven by what we have called a “turntable” 1, which, as shown, is composed of two rings 2, 3 connected one to the other by spacing webs 17, which are equipped with two radial superimposed guides 5 for each operating device 6, said turntable 1 being driven by an electric motor 69 powered by a toothed belt 4.

The cans 7, therefore, transported by said operating devices 6 can contemporaneously move circularly, radially and vertically.

Each operating device 6 is essentially composed of a rigid structure bearing two horizontal superimposed and parallel saddles 28, configured to move along two of the superimposed guides 5 of the turntable 1. Said saddles 28 have a dovetail male portion which will slide in the dovetail female portion of the guides 5.

The lower portion of each of the rigid structures bears an arm 1, near to the distal part of the lower guide 5, equipped with a horizontal rolling bearing 13 intended to be housed in the groove 15 of the horizontal static cam, which, by the rotating motion of the turntable 1, provides the radial translation motion of the operating device 6.

At the opposite side of the position of the horizontal bearing 13 of each operating device 6 the rigid structure bears a vertical guide 29, along which a rod 9 slides, at the upper end of which a plate 10 is located intended to push the bottom of the cans 7, while at the lower end there is a lubricated cage containing, in a tight manner, a ball 11 able to freely rotate in the cage.

Said ball 11 is intended to roll on a variable level closed track 12 along a trajectory, whose vertical projection is on a circle except for a lower horizontal straight portion corresponding to a chord of said circle. The chord concerned encompasses an arc of a circle variable about 60°.

At a level between the lower saddle 28 and the upper one 28 the rigid structure bears a sort of horizontally opening elastic clamp 30 having two self-lubricating plastic polymer jaws whose inner shapes are fittable to the cylindrical area of the cans 7 along a development arc, opposite to its opening, only higher than 180°.

Thus said clamp 30 enables the can 7 to be laterally inserted by a simple lateral pressure, made by a star-like rotor 66, while the holding is guaranteed by an adjustable spring 31 located at the part opposite to its opening with respect to its fulcrum 32.

The pressure of the clamp 30 on the cylindrical wall of the can 7 is such to allow it to vertically upwardly slide due to the vertical rod 9 pushing it when said rod 9 is forced to lift due to the ball 11 rolling along the cam track 12.

The rigid structure at its upper part bears another sort of clamp 23 equipped with two jaws whose inner shape is similar to that of the lower clamp 30.

The opening and closing of its jaws, unlike the lower clamp 30, is driven by a rod 33, which bears at its end a horizontal bearing 34 sliding along a circular profile 35 or stationary cam, integral with the base frame. Said rod 33 is pushed during the rotation of the turntable 1 towards the outside by the stationary cam 35 and towards the inside by a compression coil spring 36 surrounding the rod 33 itself, compressed between the fork 37 supporting the horizontal bearing 34 and the rigid structure of the operating device 6.

The rod 33 is integral with a wedge 38 coaxial thereto, whose two sloped planes are vertical and symmetric with respect to the axis of the rod 33.

The two driving arms 39 of the clamp 23 are articulated on a fulcrum integral with the structure of the operating device 6.

At the end of the two arms 39 of the clamp 23 there are two vertical cylindrical pawls 41 mounted on two pins. Said pins arranged on the end of the arms 39 of the clamp are connected to each other by one or two tension coil springs 40. Said pawls 41 are always in contact with the rod 33 whose section is locally quadrangular or with the sloped sides of the wedge 38. When the rod 33 is pushed by the stationary cam 35 by the horizontal bearing 34, the two pawls are moved away from each other by the inclined surfaces of the wedge 38, thus allowing the clamp 23 to close, while when the rod 33 is pushed in an opposite direction by the compression coil spring 36, the two pawls 41 move down along the sloped walls of the wedge 38, thus allowing the clamp 23 to elastically open by means of the return springs 40.

In the gap between the two clamps 23 and 30 there is the gripper 42 for gripping the plastic polymer tape 43 to be applied as a seal on the upper rim of the cans 7.

The gripper 42 is composed of a fixed part integral with the rigid structure of the operating device 6 at the top it is composed of a first rigid ring 42s, with an inner diameter higher than that of the can 7 which is connected, by four columns 45 or vertical spacers, to a second horizontal ring 42i, parallel to the first one, which in the lower part is equipped with a circular groove 46 housing an annular seal. Underneath and adherent to the upper fixed part of the gripper 42, namely under the ring 42s, there is the hot air diffuser 44 that serves for circularly cutting the scrap of the plastic polymer membrane. A lip seal 47 made of heat resistant plastic material is engaged to the first upper ring 42s, whose inner diameter faces the upper aperture of the diffuser 44 such to leave the cans 7 to pass in contact.

The gripper 42 further comprises a rigid member 48, vertically movable, that can slide along a vertical guide fastened to the rigid structure of the operating device 6. This movable rigid member 48 is integral, at its upper end, with another rigid horizontal ring 49, integral thereto, which bears at its upper surface a concentric ring 70 having a diameter equal to that of the ring 42i, which is also equipped with a circular groove 46 equal to that of the ring 42, which houses another annular seal. The rim of the holes of the rigid ring 42i and of the ring 70 fastened on the top of the ring 49 are suitably rounded such to better stretch the membrane 8 to be applied to the cans 7.

In order to close the jaws of the gripper 42 the rigid vertical member 48 bearing the lower horizontal rigid ring 49, that is the lower jaw, has to be lifted. The upward movement, as downward movement, is caused by a “L” shaped linkage 50 having its fulcrum at its angle. The vertical arm 51 can be pushed, causing the gripper 42 to open, by the rod 52 equipped with the bearing 53, which is pushed by the circular stationary cam 54, or it can be pulled, causing the gripper 42 to close, by return coil springs 55, anchored to the rigid structure of the operating device 6. The end of the horizontal arm 56, on the contrary, is engaged between an adjustable strut 57 fitted in the movable vertical sliding member 48 and a striding element 58 it being also attached to said vertical member 48.

Underneath the first rigid perforated ring 42s of the fixed part of the gripper 42 there is provided a hot air diffuser 44 composed of a toroidal box, kept and placed concentric to the holes of the rings 42s and 42i by means of the four vertical columns, which is made with an externally closed torus shape made of sheet, which takes, on the outside, the shape of a mouth 59 whose horizontal opening, for simplicity reasons, is quadrangular and opens downwardly while the diameter of the circular opening of the torus is slightly higher than that of the cans 7 that pass through it.

The lower mouths 59 of the diffusers slide on a circular duct 24 concentric with the turntable 1 bearing a continuous longitudinal slit 25 that feeds hot air, while the contiguous side edges of each rectangular mouth bear two thin horizontal elastic blades 60 that superimpose, by imbricating each other, the ones of the contiguous mouths 59, which reduce hot air leaks. Another way to feed the diffusers, in this case composed of tori made of a box-like sheet closed on the outside and opened on the inside, is to apply to them flexible hoses 61 connected to a central dispenser 62 located at the axis of rotation of the turntable 1, which dispenser 62 enables hot air to pass with ports obstructable only when the diffusers 44 pass in the circular sector of the turntable 1 corresponding to the step cutting the membrane 8.

### Plant for Feeding the Stretchable Plastic Polymer Tape

The plant concerned is essentially composed of a reel 63 containing a tape 43 of stretchable plastic polymer and of a series of tension means 64 and tension adjusters, which enable the tape 43 to be laterally introduced between the jaws 42i and 70 of the gripper 42 that applies the seals. Therefore, the tape 43 arrives as tangent to the straight geometric chord where the cans 7 are aligned and here it is pinched by the jaws 42i and 70 of the gripper 42 and is applied by stretching it on the top of the cans 7, that is on their openings, due to the lifting of the cans 7 produced by the rod 9 of the operating device.

Firstly the cans 7 are fed linearly by an auger 65, then a star-like rotor 66 intercepts them and take the cans 7 from the auger 65, and finally it pushes them between the jaws of the elastic clamp 30 of the operating devices 6.

### Plant Operation

The cans 7 are directed towards an auger 65, which moves them at the operating speed of the plant. The star-like rotor 66 synchronized with the auger 65 collects the cans 7 one by one and, rotating them of about 200°, fits them between the elastic jaws of the lower clamp 30 of the operating device 6. After a rotation of about 15° of the turntable 1, the groove-like stationary cam 15, by the bearing 13 of the arm 1, progressively slides along the radial guides 5 of the two rings 2, 3 of the turntable 1 the operating devices 6, which are forced to travel the cans 7 along a straight trajectory along a chord of the constant radius rotation circle of the trajectory of the cans 7.

Upon the entrance of the operating devices 6 in said straight trajectory the jaws of the grippers 42 open. Advancing along the trajectory of said chord the jaws of the grippers 42 progressively close thus pinching the tape 43 of stretchable plastic polymer, which meanwhile is introduced between the open jaws during the last curvature portion preceding the straight chord of the rotation circle of the cans 7.

Now, the vertical lifting rods 9, moved by the stationary cam 12 that increases its level by increasing its slope, push the cans 7 corresponding thereto upwardly causing them to slip between the jaws of their lower elastic clamps 30. With such vertical motion of the cans 7, the membrane 8 of the tape 43 of plastic polymer pinched between the jaws 42i and 70 of the closed gripper 42 is stretched on the upper rim of the cans 7 and here it adheres by an annular area reduction caused by the forced radial orientation of the molecules of the stretchable polymer.

Upon the arrival at a certain vertical programmed level the cans 7 are surrounded by the tori of the hot air diffusers 44 bordered at the top by the lip seal 47. Now the track 12 of the static cam acting on the rod 9 travels for an arc of a circle at a constant level and the cans 7 rotate with the turntable 1 on a horizontal plane.

During this arc of rotation on this horizontal plane the hot air flows into the diffusers 44, clear-cutting the membranes 8 applied exactly at the level of said lip seal 47.

Then the track of the static cam 12 raises again and the vertical rods 9 of the operating devices 6 push further upwardly the cans 7 now sealed between the open jaws at the proper location of the upper clamps 23 driven by the stationary cam 35 and by the coil return spring 36. Once the cans arrive at the highest programmed level the jaws of the clamps 23 close, while the track of the stationary cam 12 that drives the vertical rods 9 of the operating devices 6 stabilizes on said horizontal plane forcing the cans 7 to rotate with a constant radius going towards the exit of the turntable 1.

When the cans arrive at about 280° of rotation of the turntable 1, starting from the center) (0°) of the geometric chord, they fall on a plane, namely, a metal plate 26, which has a level lead-in which plane is flanked with a curved vertical wall 67. The cans 7 then are deviated from the trajectory of their rotation with constant radius of the turntable 1 and the jaws of the upper clamps 23 open by releasing them. Once released, a star-like rotor 27 collects them one by one and it sends them, aligned against a circular wall, to the exit where they can be removed by a conveyor belt. Once the cans 7 are on said metal plate 26 the track 12 of the cam setting the operating levels abruptly moves down with a sudden negative progressive slope to finally reach the lower base level by progressively reducing the negative slope.

### BRIEF DESCRIPTION OF THE DRAWINGS

FIG. 1 is a plan view of a plant according to the invention showing the feeding and discharging of cans.

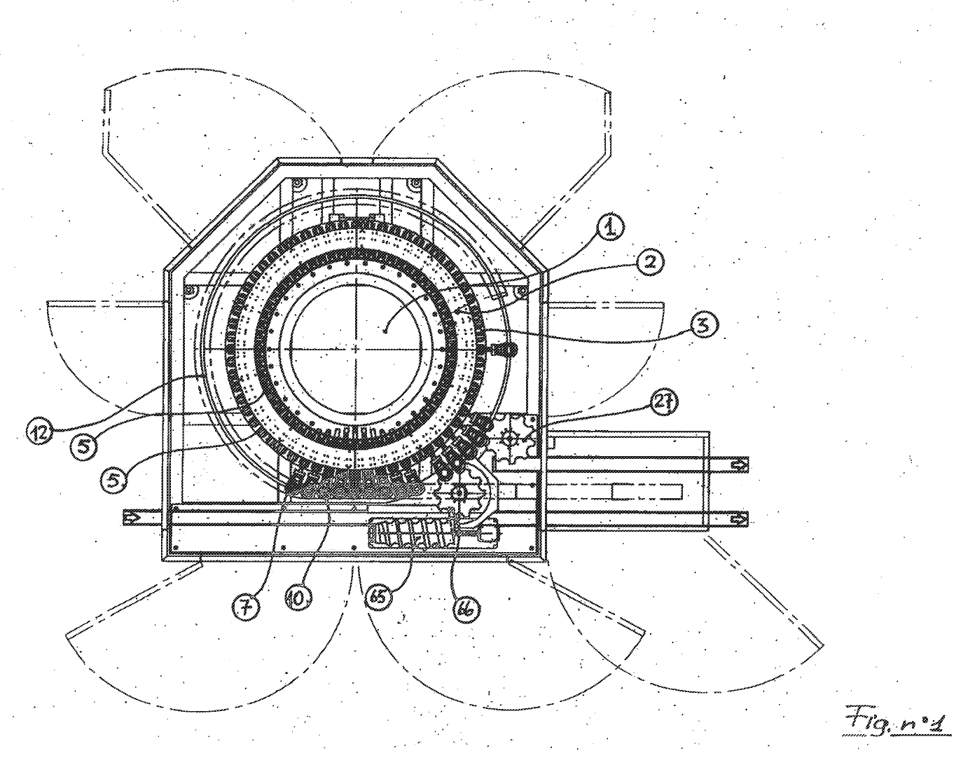

FIG. 2 shows different sections and an axonometric projection of the turntable.

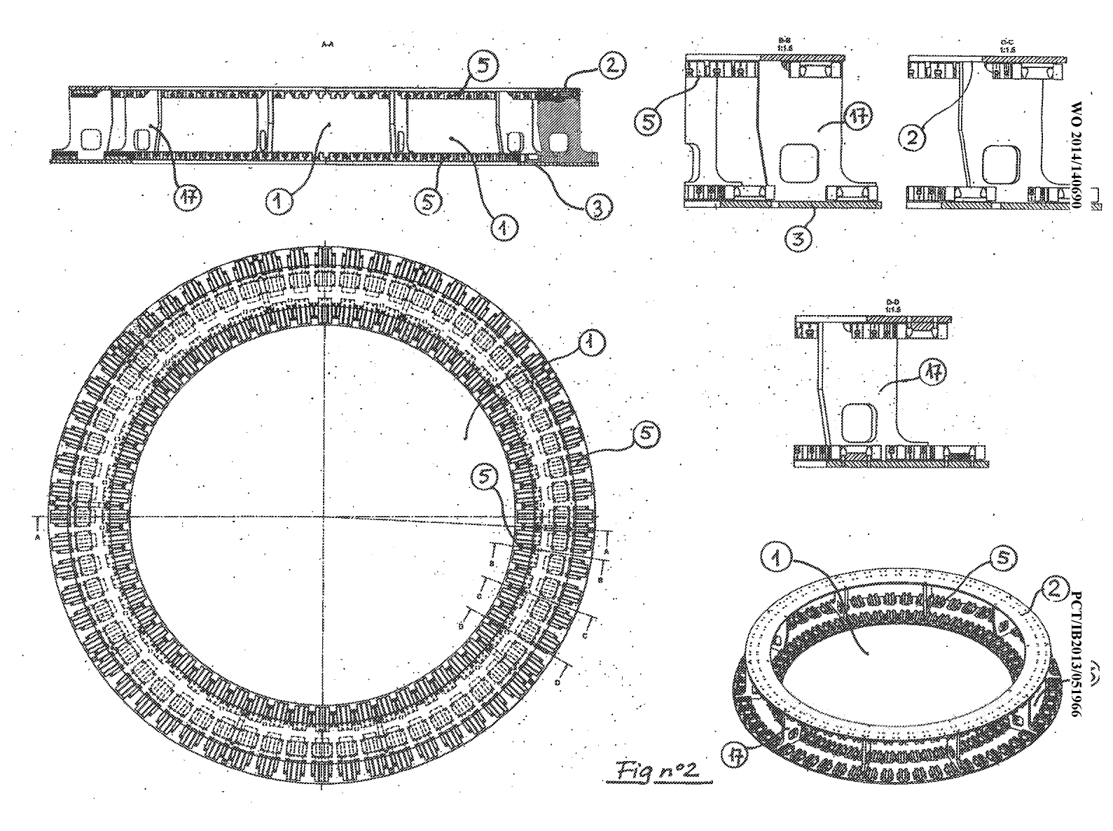

FIG. 3 shows different sections, details and an axonometric projection related to the rotating means of the turntable.

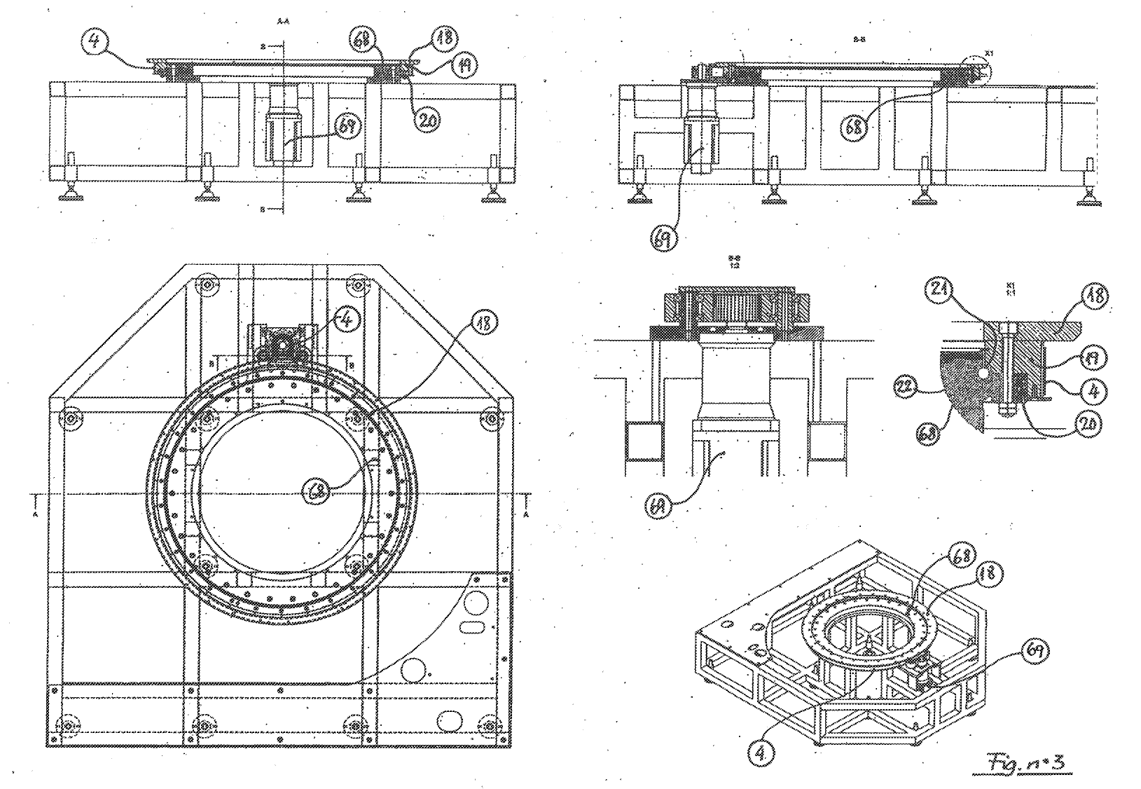

FIG. 4 shows a side view of the movement of the cans and a clear plan section of the plant.

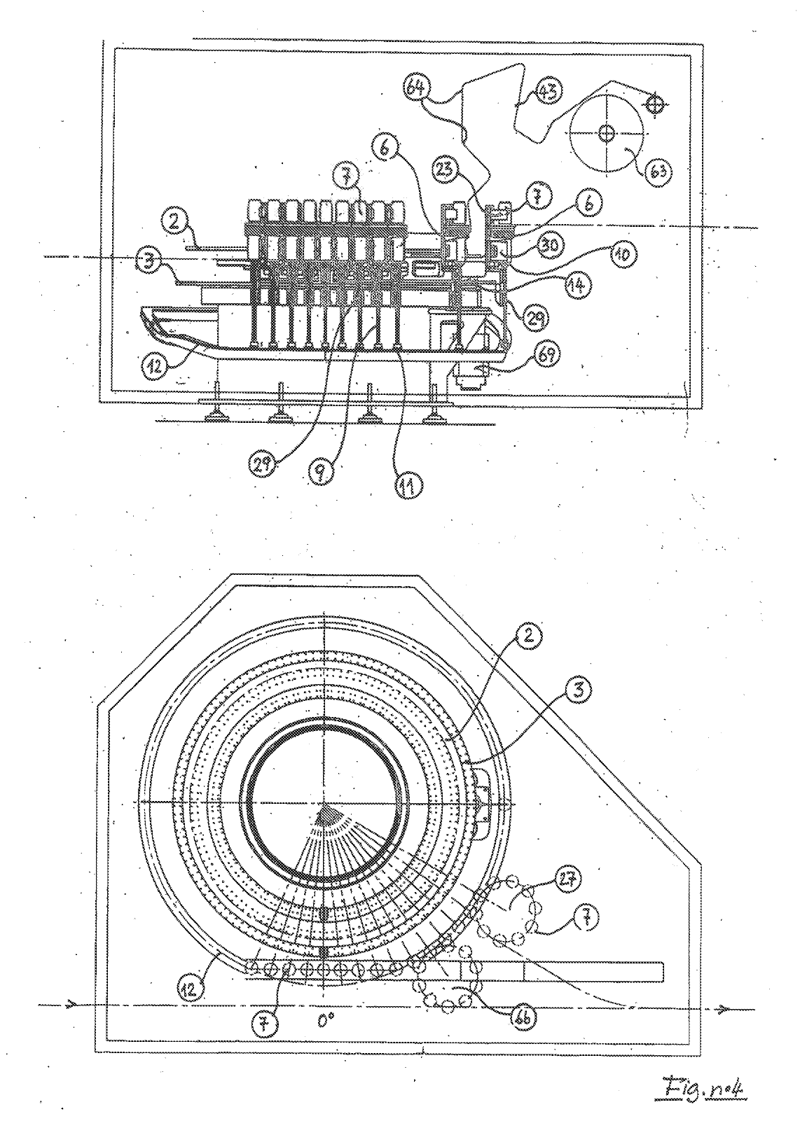

FIG. 5 shows various sections and plans of an operating device.

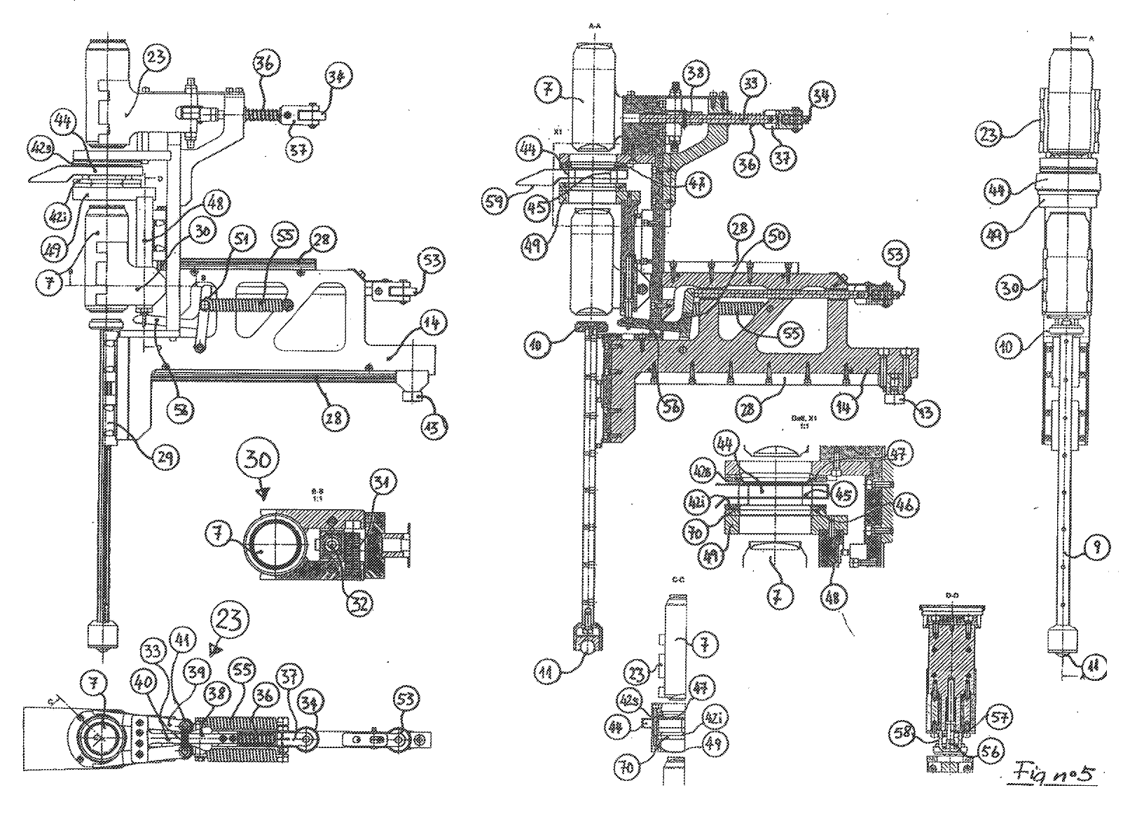

### LIST OF REFERENCE NUMBERS

1) Turntable

2) Rigid upper ring of the turntable 1

3) Rigid lower ring of the turntable 1

4) Transmission toothed belt

5) Radial guides

6) Operating device

7) Cans

8) Protective membrane made of stretchable plastic polymer

9) Vertical rod lifting the cans 7

10) Plate of the rod 9

11) Caged rotating ball

12) Track with variable level and slopes acting as a vertical cam

13) Horizontal ball bearings of the arms 14

14) Radial moving arms

15) Annular groove of the ring 16 ***

16) Ring equipped with the groove 15 acting as a horizontal cam ***

17) Webs between the rings 2 and 3

18) Upper ring supporting the turntable 1

19) Intermediate ring supporting the turntable 1

20) Lower ring supporting the turntable 1

21) Circular external groove for sliding the balls

22) Circular internal groove for sliding the balls

23) Controlled upper clamp

24) Circular duct for hot air ***

25) Longitudinal slit of the circular duct 24 ***

26) Plate with inclined lead-in ***

27) Output star-like rotor

28) Horizontal saddles of the operating device 6

29) Vertical guide of the rod 9

30) Lower automatic elastic clamp

31) Adjustable spring for the lower automatic elastic clamp 30

32) Fulcrum of the clamp 30

33) Horizontal rod moving the upper clamp 23

34) Horizontal bearing of the rod 33

35) Horizontal stationary cam with circular profile and variable radius ***

36) Compression coil spring of the rod 33

37) Fork of the bearing 34

38) Perforated prism for widening the clamp 23

39) Control arms of the clamp 23

40) Coil spring between the pins of the pawls

41) Pins of the arms 39 of the clamp 23

42) Gripper

42s) Upper rigid ring with fitting for the seal 47

42i) Upper rigid ring of the gripper 1 with groove 46 (upper jaw)

43) Tape of stretchable plastic polymer

44) Toroidal diffuser for hot air ***

45) Columns supporting the toroidal diffuser 44

46) Grooves housing the seals of the rings 42i and 70

47) Heat resistant lip seal for cutting the membrane 8

48) Rigid vertically movable member of the gripper 1

49) Horizontal ring with groove 46 integral with the rigid member 48 (lower movable

50) Linkage lifting the rigid movable member

51) Vertical arm of the linkage 50

52) Rod equipped with top bearing 53 for operating the linkage 50

53) Horizontal ball bearing of the rod 52

54) Circular cam with variable radius profile for operating the linkage 50 ***

55) Return spring of the linkage 50

56) Horizontal arm of the linkage 50

57) Strut adjusting the movable rigid member 48

58) Striding element retaining the horizontal arm 56

59) Quadrangular mouth of the diffuser 44

60) Imbricated elastic blades of the quadrangular mouth 59

61) Flexible hoses for hot air (not shown in the drawings) ***

62) Central dispenser of hot air ***

63) Reel of the stretchable plastic polymer tape 43

64) Tension means and adjusters of the stretchable plastic polymer tape 43

65) Auger

66) Feeding star-like rotor

67) Vertical wall deviating the cans 7 ***

68) Base ring with groove 22 mounted on the stationary base structure of the plant

69) Motor

70) Ring with groove 46 of the lower jaw of the gripper 42

Note: The elements of the legend marked by a triple asterisk are not shown in the figures such to facilitate its interpretation. However they are as identity references for facilitating the reading of the text.

The invention claimed is:

1. Plant for applying protective membranes on beverage cans (7) comprising:
a turntable (1) rotating about a virtual and vertical axis, the turntable being driven by an electric motor through a toothed belt (4) made of a first and a second rings (2 and 3) integral with each other and having surfaces, a lower surface being of the first ring (2) and an upper surface being of the second ring (3), each bearing a series of an equal number of guides (5) that are horizontally and radially and angularly equally spaced,
wherein each guide (5) of the first ring (2) vertically corresponds to a guide (5) of the second ring (3),
wherein, to each vertical pair of two superimposed guides (5), there is engaged an operating device (6) so as to radially move the operating device, and
wherein the operating device is equipped with a pair of horizontal and radial saddles (28) and is configured to circularly, radially and vertically move the beverage cans (7), to which a protective membrane (8) made of a stretchable plastic polymer is to be applied.

2. The plant according to claim 1, wherein all operating devices (6) are equipped with a vertical rod (9) having an upper plate (10) configured to vertically push the beverage cans (7) and with a lower caged rotating ball (11) configured to slide along a track (12), and wherein the track (12) has a variable level and slopes, and acts as a stationary cam integral with a plant base, thereby providing for a vertical movement of the beverage cans (7) generated by a rotation of the turntable (1).

3. The plant according to claims 1, wherein each of the operating devices (6) has a horizontal arm (14) equipped with a horizontal top bearing (13) with a vertical axis such to slide in a quadrangular section groove (15) and act as a horizontal static cam, wherein the section groove (15) is obtained on an upper surface of a rigid ring (16) integral with a base structure of the plant, and wherein the horizontal arms (14) with the corresponding bearings (13) guided by the groove (15) provide for a radial movement of the operating devices (6) that move the beverage cans (7).

4. The plant according to claim 1, wherein the turntable (1), having a rotating part comprises the first ring (2), which is rigid, in upper horizontal position, and with a constant radius, and the second ring (3), which is rigid, in lower horizontal position, and with a constant radius, concentric and integral with the first ring by way of radial and vertical webs (17), wherein, on each of the upper and lower surfaces of the first and second rings (2, 3), the guides (5) are secured that are radially, angularly, and equally spaced with a dovetail section, wherein the turntable rotates engaged to a concentric assembly of three rings (18, 19 and 20), two lower rings of the three rings (19 and 20) bearing at a contact of their inner diameters a groove (21) opposite to an equal groove (22) obtained in an outer face of a fourth ring (68) integral with a stationary structure of the plant, and wherein, in the opposite grooves (21 and 22), there are provided rolling balls while a toothed belt (4) driven by a powered electric motor (69) and acting on an outer surface of an intermediate toothed ring (19) of the three rings, thereby causing the turntable to rotate synchronously with a feeding of the beverage cans (7) to be sealed and with a discharge thereof.

5. The plant according to claim 1, wherein all the operating devices (6) are equipped with two horizontal, parallel and superimposed saddles (28) configured to slide, vertically engaged, along the guides (5) of the first and second rings (2 and 3).

6. The plant according to claim 2, wherein all the operating devices (6) bear a lower elastically opening clamp (30) equipped with a fulcrum (32) and an adjustable spring (31) in whose jaws the beverage cans (7) are fitted by a synchronized feeding star-shaped rotor (66), and wherein said beverage cans (7) slide when pushed, forced, by the vertical rod (9) with the upper plate (10).

7. The plant according to claim 3, wherein all the operating devices (6) bear an upper clamp (23) to grasp and release the beverage cans (7), the clamp being opened or closed by a horizontal movement of a rod (33) equipped with a horizontal top bearing (34) mounted on a fork (37) and with a coaxial coil return spring (36), the rod (33) having a quadrangular and being equipped with an wedge (38) integral therewith and coaxial to vertical walls having surfaces on which two pawls (41) are mounted on vertical pins fastened at ends of arms (39) of the upper clamp (23), the pawl rolling such to move the arms away from each other, and so to close the upper clamp, when the horizontal cam (35) with a variable radius pushes the rod (33) by the bearing (34), or such to move the arms one near the other when the coaxial spring (36), by pushing back the rod (33), allows the coil return spring (40) to open the upper clamp (23).

8. The plant according to claim 1, wherein all the operating devices (6) are equipped with two rigid rings (42i and 70) both equipped with grooves (46) faced to each other and configured to house elastic seals and having edges of their inner diameters that are rounded, the two rigid rings (42i and 70) being two jaws of a gripper (42) configured to pinch a tape (43) of the stretchable plastic polymer.

9. The plant according to claim 8, wherein the rigid ring (49), at a lower jaw of the gripper (42), is integral with a rigid member (48) vertically movable and sliding along a guide which, pushed by a horizontal arm (56) of a linkage (50), presses said rigid ring (49), integral with the lower jaw (70) of the gripper (42), against the rigid ring (42i), at an upper jaw of the gripper (42).

10. The plant according to claim 9, wherein the linkage (50) operating a vertical coming and going movement of the rigid member (48) is comprises a vertical arm (51) and a horizontal arm (56) engaged and orthogonal to each other and articulated about a fulcrum near an intersection of said vertical and horizontal arms (51 and 56), wherein the vertical arm is operated by a horizontal rod (52) equipped with a horizontal bearing (53) which rolls against a horizontal, circular, and stationary cam (54) integral with a base of the plant and having a variable radius profile, and by a pair of return springs (55), and wherein the horizontal arm has its end in close contact between an adjustable strut (57) housed in the rigid member (48) and a striding element (58) inserted in the rigid member (48).

11. The plant according to claim 9, wherein all the operating devices (6) of the turntable (1) have a diffuser (44) comprising a toroidal box equipped with a side opened mouth (59) to an outside and with a quadrangular mouth (59) faced downwardly, through which hot air flows such to cut the protective membrane (8) applied on an upper rim of the beverage cans (7), wherein the hot air comes from a circular duct (24) having a longitudinal slit (25) along which the quadrangular mouths (5) slide, and wherein between said side mouths, (59) there are provided flat elastic blades (60) imbricated with each other to reduce interstitial leaks of the hot air.

12. The plant according to claim 11, wherein the diffuser (44) is kept in position by four spacing columns (45), equally spaced from each other, which are arranged on a circle whose diameter, subtracting twice a radius of the columns (45), is higher than a diameter of the beverage cans (7), and wherein the columns (45) at tops thereof are integral with a fixed ring (42s), on an inner diameter of which the seal (47) is retained exactly delimiting a cut of the membrane (8) and at bottoms thereof with the ring (42i) at the upper jaw of the gripper (42), which is fixed.

13. The plant according to claim 11, wherein the toroidal diffusers (44) have no side mouths (59) but are directly fed by hoses (61) coming from a fixed central cylindrical hot air dispenser (62) provided with a port shaped as a horizontal aperture travelling along an arc of a cylindrical surface corresponding to an arc, during which the membranes (8) are cut, the port feeding hot air when ends of the hoses (61) feeding each operating device (6) tightly pass in front of said horizontal aperture.

14. The plant according to claim 7, wherein, at a higher rotation level of the beverage cans (7), corresponding to plane defined at bottoms of the beverage cans (7) and at an angle of a programmed exit of the beverage cans, there is arranged a horizontal plate (26) equipped with an inclined lead-in and a vertical curved deviating wall (67) providing to collect the beverage cans (7) released by the clamps (23), the beverage cans being taken again by an output star-shaped rotor (27) that directs the beverage can in aligned arrangement towards a conveyor belt.
